(19) United States
(12) Patent Application Publication
(10) Pub. No.: US 2012/0281129 A1
(43) Pub. Date: Nov. 8, 2012

(54) CAMERA CONTROL

(75) Inventors: Kong Qiao Wang, Beijing (CN); Suresh Chande, Espoo (FI)

(73) Assignee: Nokia Corporation

(21) Appl. No.: 13/102,671

(22) Filed: May 6, 2011

(51) Int. Cl. H04N 5/225

(52) U.S. Cl. 348/333.01; 348/E05.024

(57) ABSTRACT

Apparatus has at least one processor and at least one memory having computer-readable code stored thereon which when executed controls the at least one processor: to receive gestural data representing a user gesture made independently of any touch-based input interface of a device; to identify from the gestural data a corresponding camera command associated with the user gesture; and to output the identified camera command to control the at least one camera.

### FIELD OF THE INVENTION

This invention relates generally to camera control on a terminal, particularly using gestures received independently of a touch-based interface of the terminal.

### BACKGROUND TO THE INVENTION

It is commonplace for terminals, particularly mobile communications terminals, to comprise one or more cameras.

In the context of this application, a camera is assumed to mean a digital camera capable of generating image data representing a scene received by the camera's sensor. The image data can be used to capture still images using a single frame of image data or to record a succession of frames as video data.

It is known to use video data received by a camera to enable user control of applications running on a terminal. Applications store mappings relating predetermined user gestures detected using the camera to one or more commands associated with the application. For example, a known photo-browsing application uses hand-waving gestures made in front of a terminal's front-facing camera to control how photographs are displayed on the user interface, a right-to-left gesture typically resulting in the application advancing through a sequence of photos.

Some terminals comprise both front- and rear-facing cameras. Prior art applications which run on the terminals enable switching between the cameras by providing a dedicated ‘swap’ icon provided as part of the application's graphical user interface (GUI) which requires the user to touch the button on the GUI.

Disadvantages exist in that developers have to incorporate a dedicated function and icon to effect touch-based control of the camera or cameras via a GUI, e.g. to enable/disable and/or swap between the front and rear cameras. Furthermore, the requirement for users to touch the interface can be problematic in situations where the user cannot hold or touch the terminal, for example when driving or giving a presentation, or where the user is using a rear-facing camera because this camera is on the opposite side to the touch-based interface.

### SUMMARY OF THE INVENTION

A first aspect of the invention provides apparatus comprising a gesture recognition system configured to detect one or more predetermined user gestures independent of any touch-based interface and to control at least one camera in response to detecting the or each predetermined user gesture.

The apparatus may be configured to disable an enabled camera in response to detecting a predetermined user gesture. The apparatus may be configured to control first and second cameras, wherein the gesture recognition system is further configured to enable a currently-disabled camera in response to detecting the predetermined user gesture.

The gesture recognition system may be configured to receive video data from an enabled camera and to identify from the video data one or more predetermined user gestures. The gesture recognition system may be configured to identify, from the received video data, a gesture represented by a motion vector associated with a foreground object's change of position between subsequent frames of video data, and to compare said motion vector with a set of predetermined reference motion vector to identify a corresponding control command for the at least one camera.

The gesture recognition system may be configured to receive motion signals from a motion sensor and to identify therefrom one or more predetermined user gestures corresponding to said movement. The motion sensor may include at least one of an accelerometer and a gyroscope, the motion signal being generated based on at least one of a change in acceleration and a change in orientation of the apparatus.

The gesture control system may be configured to disable the display of video data from a currently selected camera in response to detection of a predetermined motion gesture and to enable the display of video data from the other, non-selected camera.

A second aspect of the invention provides apparatus, the apparatus having at least one processor and at least one memory having computer-readable code stored thereon which when executed controls the at least one processor:
to receive gestural data representing a user gesture made independently of any touch-based input interface of a device;
to identify from the gestural data a corresponding camera command associated with the user gesture; and
to output the identified camera command to control the at least one camera.

A third aspect of the invention provides a method comprising:
receiving gestural data representing a user gesture made independently of any touch-based input interface of a device;
identifying from the gestural data a corresponding camera command associated with the user gesture; and
outputting the identified camera command to control the at least one camera.

The outputted command may be configured to disable a currently-enabled camera. The outputted command may be configured to enable a currently-disabled camera.

Receiving gestural data may comprise receiving video data from the at least one camera and identifying from the video data one or more predetermined user gestures. Receiving gestural data may further comprise identifying a motion vector associated with a foreground object's change of position between subsequent frames of video data, and comparing said motion vector with a set of predetermined reference motion vectors to identify a corresponding control command for the or each camera. Receiving gestural data may comprises receiving a signal from a motion sensor provided on the device, the signal being representative of movement of the device, and identifying therefrom one or more predetermined user gestures corresponding to the sensed movement. The signal may be received from at least one of an accelerometer and gyroscope, the signal being generated based on at least one of a change in acceleration and a change in orientation of the device.

The method may comprise, in response to detection of a predetermined motion gesture, disabling display of video data from a currently selected camera and enabling the display of video data from a non-selected camera.

Another aspect provides a computer program comprising instructions that when executed by a computer apparatus control it to perform any method above.

Another aspect provides a portable device comprising any of the apparatus above.

A further aspect of the invention provides a non-transitory computer-readable storage medium having stored thereon computer-readable code, which, when executed by computing apparatus, causes the computing apparatus to perform a method comprising:
receiving gestural data representing a user gesture made independently of any touch-based input interface of a device;
identifying from the gestural data a corresponding camera command associated with the user gesture; and
outputting the identified camera command to control the at least one camera.

### BRIEF DESCRIPTION OF THE DRAWINGS

Embodiments of the present invention will now be described, by way of example only, with reference to the accompanying drawings, in which:

FIG. 1 is a perspective view of a mobile terminal embodying aspects of the invention;

FIG. 2 is a schematic diagram illustrating components of the FIG. 1 mobile terminal and their interconnection;

FIG. 3 is a schematic diagram illustrating certain components shown in FIG. 2 relevant to operation of a gesture recognition system of the invention;

FIG. 4 is a flow diagram indicating the generalised processing steps performed by the gesture recognition system shown in FIG. 3;

FIG. 5 is a perspective view of the mobile terminal shown in FIG. 1 which is useful for understanding a first embodiment;

FIG. 6 shows a look-up-table employed by the gesture recognition system in the first embodiment;

FIG. 7 is a flow diagram indicating the processing steps performed by the gesture recognition system in the first embodiment;

FIGS. 8a and 8b are perspective views of the mobile terminal shown in FIG. 1 employed in use according to the first embodiment;

FIG. 9 is a perspective view of the mobile terminal shown in FIG. 1 which is useful for understanding a second embodiment;

FIG. 10 shows a look-up-table employed by the gesture recognition system in the second embodiment; and

FIG. 11 is a flow diagram indicating the processing steps performed by the gesture recognition system in the second embodiment.

### DETAILED DESCRIPTION OF PREFERRED EMBODIMENTS

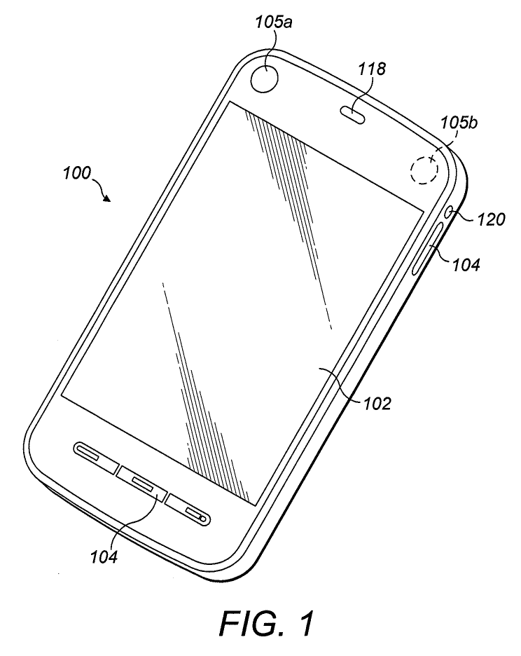

Referring firstly to FIG. 1, a terminal 100 is shown. The exterior of the terminal 100 has a touch sensitive display 102, hardware keys 104, front and rear cameras 105a, 105b, a speaker 118 and a headphone port 120.

The front camera 105a is provided on a first side of the terminal 100, that is the same side as the touch sensitive display 102. The rear camera 105b is provided on the opposite side of the terminal.

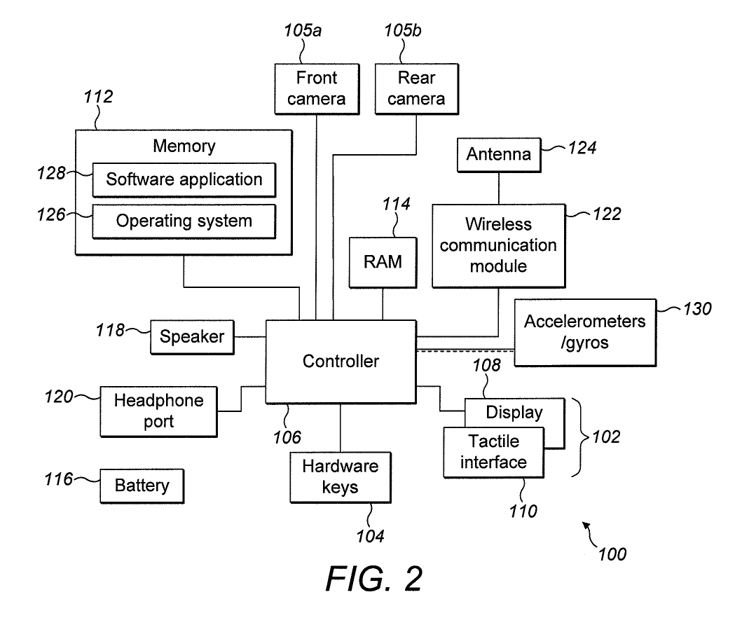

FIG. 2 shows a schematic diagram of the components of terminal 100. The terminal 100 has a controller 106, a touch sensitive display 102 comprised of a display part 108 and a tactile interface part 110, the hardware keys 104, the front and rear cameras 105a, 105b, a memory 112, RAM 114, a speaker 118, the headphone port 120, a wireless communication module 122, an antenna 124, motion sensors in the form of a set of accelerometers and gyroscopes 130, and a battery 116. The controller 106 is connected to each of the other components (except the battery 116) in order to control operation thereof.

The memory 112 may be a non-volatile memory such as read only memory (ROM) a hard disk drive (HDD) or a solid state drive (SSD). The memory 112 stores, amongst other things, an operating system 126 and may store software applications 128. The RAM 114 is used by the controller 106 for the temporary storage of data. The operating system 126 may contain code which, when executed by the controller 106 in conjunction with RAM 114, controls operation of each of the hardware components of the terminal.

The controller 106 may take any suitable form. For instance, it may be a microcontroller, plural microcontrollers, a processor, or plural processors.

The terminal 100 may be a mobile telephone or a smartphone, a personal digital assistant (PDA), a portable media player (PMP), a portable computer or any other device capable of running software applications and providing audio outputs. In some embodiments, the terminal 100 may engage in cellular communications using the wireless communications module 122 and the antenna 124. The wireless communications module 122 may be configured to communicate via several protocols such as GSM (Global System for Mobiles), CDMA (code division multiple access), UMTS (universal mobile telephone system), Bluetooth and IEEE 802.11 (Wi-Fi).

The display part 108 of the touch sensitive display 102 is for displaying images and text to users of the terminal and the tactile interface part 110 is for receiving touch inputs from users.

As well as storing the operating system 126 and software applications 128, the memory 112 may also store multimedia files such as music and video files. A wide variety of software applications 128 may be installed on the terminal including web browsers, radio and music players, games and utility applications. Some or all of the software applications stored on the terminal may provide audio outputs. The audio provided by the applications may be converted into sound by the speaker(s) 118 of the terminal or, if headphones or speakers have been connected to the headphone port 120, by the headphones or speakers connected to the headphone port 120.

In some embodiments the terminal 100 may also be associated with external software application not stored on the terminal. These may be applications stored on a remote server device and may run partly or exclusively on the remote server device. These applications can be termed cloud-hosted applications. The terminal 100 may be in communication with the remote server device in order to utilise the software application stored there. This may include receiving audio outputs provided by the external software application.

In some embodiments, the hardware keys 104 are dedicated volume control keys or switches. The hardware keys may for example comprise two adjacent keys, a single rocker switch or a rotary dial. In some embodiments, the hardware keys 104 are located on the side of the terminal 100.

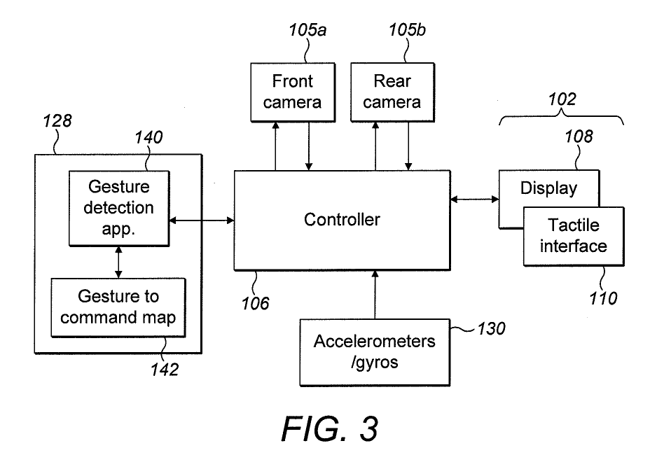

FIG. 3 shows a schematic diagram of certain components of the terminal 100 relevant to embodiments described herein. Stored on the memory 112 is a dedicated application 140, hereafter referred to as ‘the gesture detection application’. The gesture detection application is associated with operation of the front and rear cameras 105a, 105b independent of the touch sensitive display 102. The gesture detection application 140 may be provided as an integral part of the terminal's operating system 126 or as a separate plug-in module to the operating system. The gesture detection application 140 is associated with a gesture-to-command map 142, hereafter ‘command map’ which is a database storing a look up table (LUT) which corresponds one or more predefined reference gestures received through sensors of the terminal 100 to operating commands associated with the front and rear cameras 105a, 105b.

Specifically, the command map 142 stores one or more commands, which, when executed by the controller, causes switching of one or both cameras 105a, 105b between enabled and disabled modes, as well as swapping control between the cameras so that when one camera is enabled, the other is disabled. In this sense, enabling a particular one of the cameras 105a, 105b means making the controller 106 configured to receive image or video data from the enabled camera for output to the display 108 and also to enable capture of the transferred image or video data using a camera application (not shown) handling aspects such as zoom, capture and storage on the memory 112.

As will be described in greater detail below, the gesture detection application 140 identifies gestures from, in a first embodiment, either of the front and rear cameras 105a, 105b and, in a second embodiment, the motion sensing accelerometers and/or gyroscopes 130. It will therefore be appreciated that camera control can be achieved independently of the touch sensitive display 120 and indeed of other hard keys provided on the terminal 100.

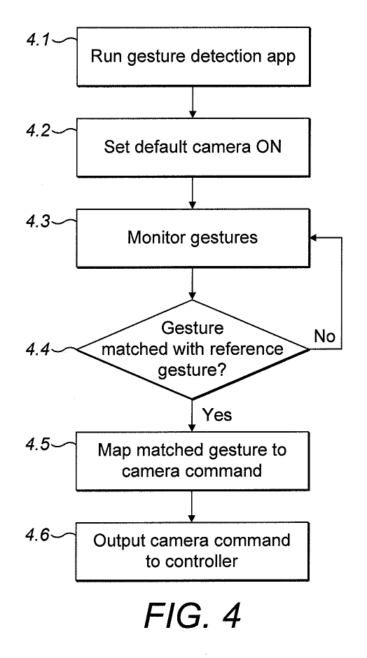

Referring to FIG. 4, the general operating steps performed by the gesture detecting application 140 are as follows. In a first step 4.1, the gesture detecting application 140 is run, and in a second step 4.2 a first one of the cameras 105a, 105b, as a default camera, is enabled. In a third step 4.3, gestures received through one or more sensors of the terminal 100 operating independently of the touch sensitive display 120 are monitored.

In a subsequent step 4.4, if a received gesture is matched with a reference gesture stored in the command map 142, it is mapped to its associated command in step 4.5 which is then executed in step 4.6 by the controller 4.6 to perform a predetermined camera function.

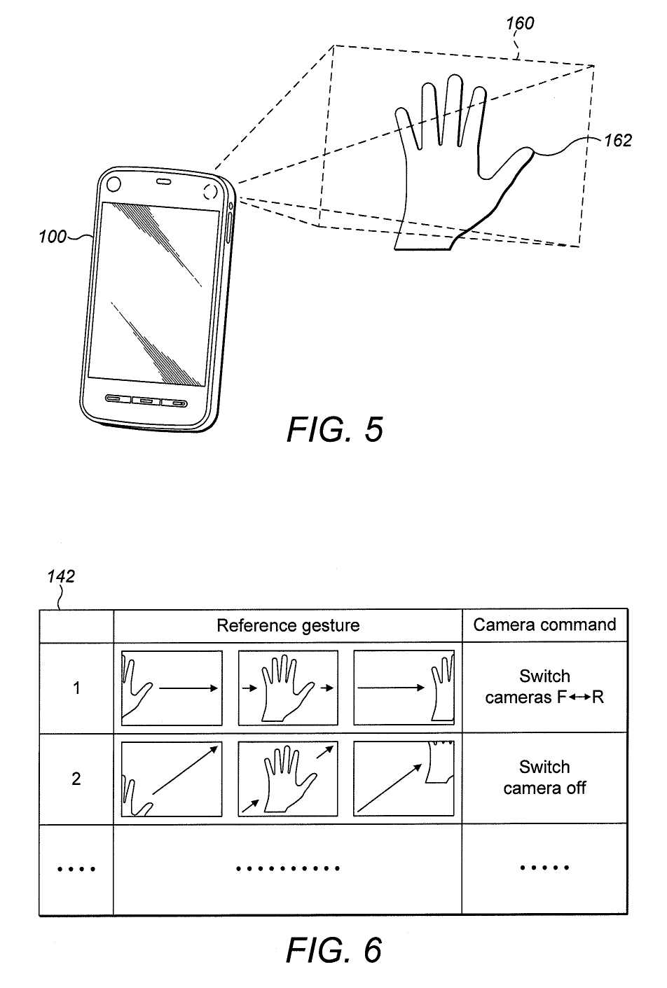

A first embodiment will now be described in greater detail with reference to FIGS. 5 to 8. In this embodiment, the front and rear cameras 105a, 105b are used to detect gestures received through an enabled one of the cameras, the gestures being in the form of hand movements. Hand movements are converted to image or, more particularly, video data for comparison with reference gestures stored in the command map 142.

Referring to FIG. 5, the terminal 100 is shown with the rear camera 105b, in this case the default camera, enabled. Dotted lines indicate a rectangular field-of-view 160 representing the spatial area covered by the sensor of the rear camera 105b. User gestures for controlling aspects of the camera's operation, through the gesture detection application 140, are in the form of hand waving movements 162. Any one of the many known video processing methods for detecting and quantifying motion in a digital camera's field-of-view can be employed. One example includes periodically establishing a background image for the frame based on predominately static pixel luminance values and thereafter detecting a foreground object based on detecting pixel values above a predetermined threshold compared with the background image. Alternative methods can employ foreground object detecting algorithms that do not require a background image to be established. The foreground object can thereafter be quantified and tracked in terms of its motion, e.g. as an inter-frame motion vector, to represent a gesture.

Referring to FIG. 6, a schematic representation of a command map 142 is shown. Here, a plurality of reference gestures, which in practice correspond to different foreground object motion vectors, are shown together with their corresponding camera commands. A first reference gesture #1 maps video data representative of a left-to-right hand-waving gesture to a camera_switch command, that is to alternate controller control between the front and rear cameras 105a, 105b. A second reference gesture #2 maps video data representative of a left-to-right upwards hand-waving gesture to a camera_off command, that is to disable the currently enabled camera. Other reference gestures and command mappings may be provided.

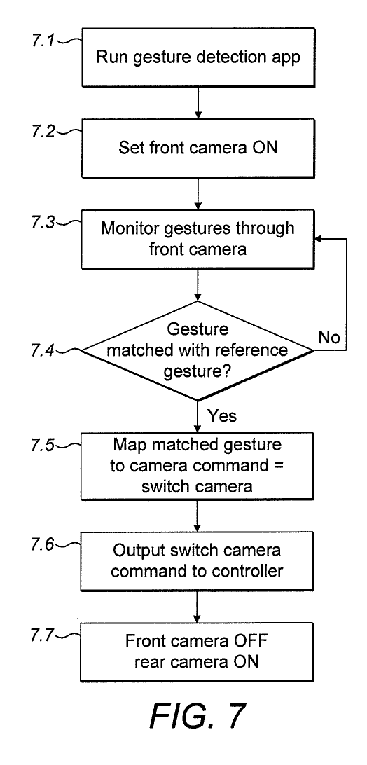

Referring to FIG. 7, the operating steps performed by the gesture detection application 140 in accordance with the first embodiment are indicated. In a first step 7.1, the gesture detecting application 140 is run. In a second step 7.2, the default, rear camera 105b, is enabled or ‘on’. In a third step 7.3, foreground objects received through the rear camera 105b are monitored. In a fourth step 7.4, if the motion of a foreground object is matched with one of the reference gestures in the command map 142, in a subsequent step 7.5, the corresponding camera command is retrieved. In this case, the switch_camera command is retrieved. In step 7.6, the gesture detection application 140 outputs the switch_camera command to the controller 106 which, in step 7.7, switches control to disable the rear camera 105b and enable the front camera 105a.

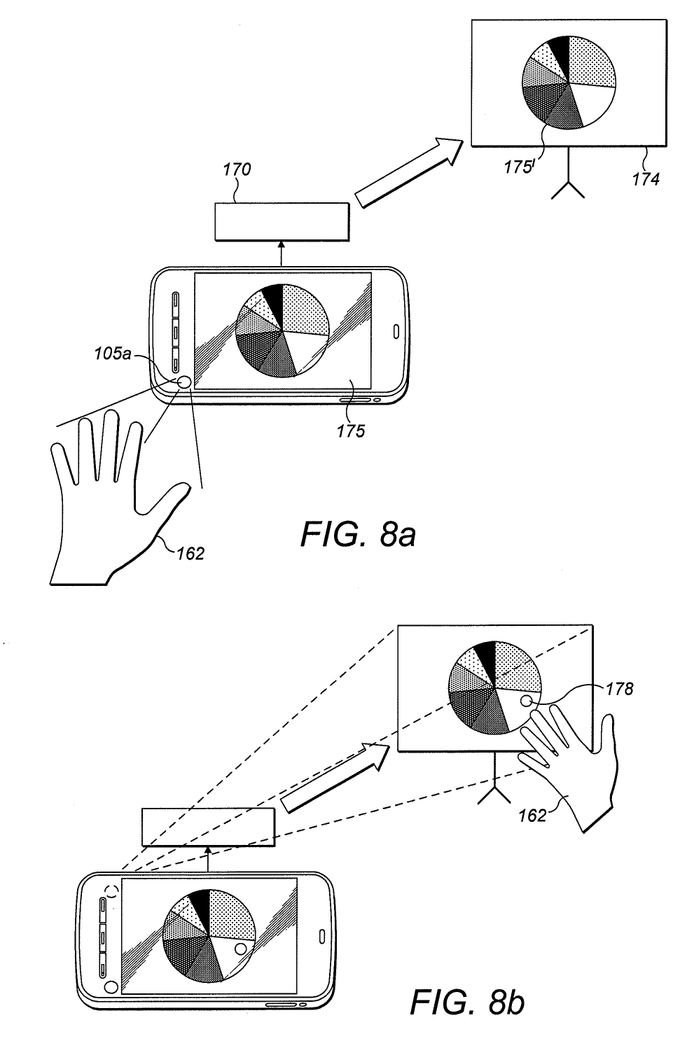

FIGS. 8a and 8b show an example of how the gesture detection application 140 can be advantageously employed.

Referring to FIG. 8a, the terminal 100 is shown running a proprietary presentation application which, in use, allows a user to generate slides and run a slideshow. The terminal 100 is shown connected to a projector 170 for displaying the output 175′ of the presentation application on a projector screen 174. Certain types of terminal 100 include their own projector system, sometimes termed ‘picoprojectors’, for this purpose. Quite separate from the gesture recognition application 140, the presentation application itself provides for gestural control of certain functions received through the front and rear cameras 105a, 105b, for example to advance forwards and return backwards through a series of slides. Such control gestures, for obvious reasons, need to be different from those employed by the gesture detection application 140 for controlling the cameras 105a, 105b.

When the user is making a presentation, they may initially enable the front camera 105a which is either the default camera or, if not, by waving their hand from right-to-left to cause the gesture detection application 140 to switch camera control from the rear camera 105b to the front camera. With the front camera 105a enabled, the user can operate the presentation application using the appropriate hand gestures to scroll through the slides. If at any time the user wishes to move in front of the terminal 100 to highlight something on the projector screen 174 by way of hand gestures, they will need to enable the rear camera 105b. Again, they may switch camera control using a right-to-left swipe gesture before the front camera 105a.

Referring to FIG. 8b, when behind the terminal 100, the user's hand is captured with the rear camera's field of view and gestures are again monitored by both the gesture recognition algorithms being employed by the gestural detection application 128 and presentation applications. In this case, a pointing finger gesture is received through the rear camera 105b and detected by the presentation application which causes a pointer 178 to be projected over the slide onto the projector screen 174, substantially in alignment with the finger. The pointer 178 thereafter tracks movement of the finger over the displayed slide. When the user wishes to revert back to the front camera 105a, a left-to-right swipe gesture is made in the field-of-view of the rear camera 105b.

This usage example demonstrates a further advantage in being able to control one or both cameras 105a, 105b remotely of the terminal 100 in that the user avoids disturbing the position of the terminal which should remain stationary in use; otherwise the terminal will need to be re-aligned with the projector screen 174.

A further point to make is that, when one of the cameras 105a, 105b is enabled, there is a relatively large power consumption. In a typical device, an enabled front camera 105a may typically run down a fully charged 1000 mAh battery in about an hour. So, the ability to switch the cameras 105a, 105b off when they are not needed is advantageous to save power and can be easily effected in the present embodiment using the relevant hand waving gesture. Consider the situation where the terminal 100 is connected to a holder on a car dashboard and the driver is using the front camera 105a to hold a hands-free conference call. If battery power is running low, the driver may wish to switch off the camera 105a and use voice-only communications. The driver avoids the need to locate and physically touch the relevant ‘off’ button terminal 100 by simply making the appropriate gesture in the camera's field-of-view. Switching the front camera 105a back on may employ detection of a different gesture, perhaps based on motion, as will be introduced in the second embodiment described below.

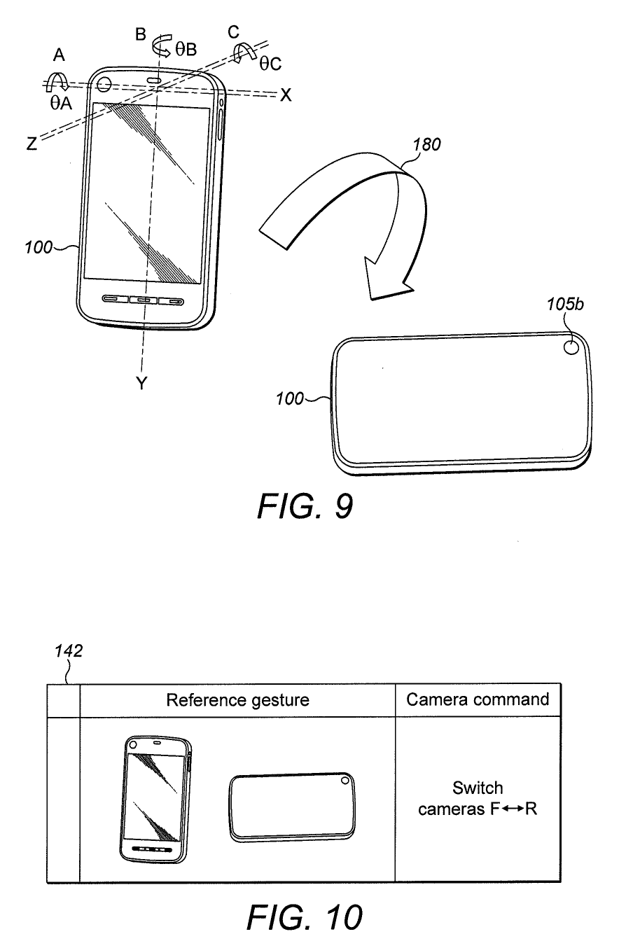

A second embodiment will now be described with reference to FIGS. 9 to 11. Here, the gesture detection application 140 is arranged to receive signals received not from the cameras 105a, 105b but from the accelerometers and/or gyroscopes 130 provided by the terminal 100. As will be appreciated, accelerometers are able to detect and measure the amount and direction of acceleration as a vector quantity. They can also be used to measure orientation, although gyroscopes are better suited for this purpose. In this embodiment, either or both are employed to generate signals from which can be interpreted a gesture based on the sensed amount, direction and orientation of movement over a predetermined time frame, e.g. half a second. For ease of explanation, these parameters are referred to collectively as motion parameters. The command map 142 in this case stores a predetermined number of reference gestures which correspond to respective quantities of the motion parameters. Each reference gesture is mapped to a respective camera control command, as was the case for the first embodiment.

Referring to FIG. 9, there is shown the terminal 100 with dotted lines X,Y,Z respectively representing the principal three-dimensional axes of the terminal which are used by the accelerometers/gyroscopes 130 as reference axes. Also shown are arrows A,B,C representing respective orientation angles θ_{A}, θ_{B}, θ_{C} of the reference axes X,Y,Z through which the terminal 100 can rotate in use. It will therefore be appreciated that, during movement, different values for amount, direction and orientation of movement can be stored against each of the three axes X,Y,Z to quantify and interpret a gesture.

In the present use example, movement corresponding to a wrist turnover action, indicated in FIG. 9, is quantified and stored as a reference gesture. Referring to FIG. 10, which shows the command map 142, this gesture corresponds with a camera switch_camera command. Although the reference gesture is shown pictorially, it will be appreciated that the above-mentioned motion parameters appropriate to a wrist-turnover motion will be stored, with a degree of tolerance allowed to account for appreciable differences in movement that will result from use by different people.

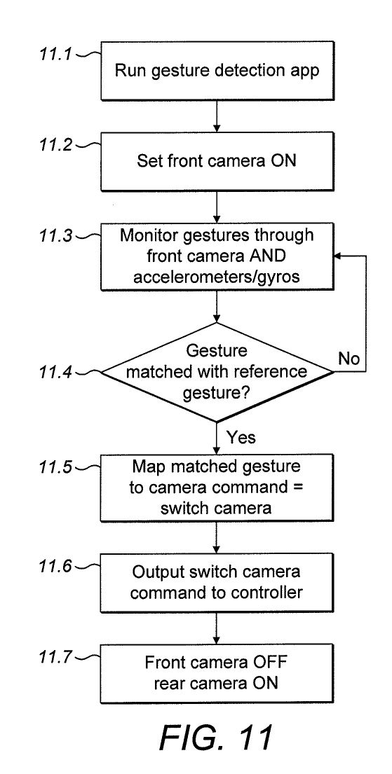

Referring to FIG. 11, the operating steps performed by the gesture detection application 140 in accordance with the second embodiment are indicated. In a first step 11.1, the gesture detecting application 140 is run. In a second step 11.2, the default, rear camera 105b, is enabled or ‘on’. In a third step 11.3, the motion parameters received from the accelerometers/gyroscopes 130 are monitored. In a fourth step 11.4, if the motion parameters are matched with the reference gesture in the command map 142, in a subsequent step 11.5, the corresponding camera command is retrieved. In this case, the switch_camera command is retrieved. In step 11.6, the gesture detection application 140 outputs the switch_camera command to the controller 106 which, in step 11 m g.7, switches control to disable the rear camera 105b and enable the front camera 105a.

In general, the second embodiment avoids conflict problems that may arise in the first embodiment where both the gesture detection application 140 and a proprietary application use gestural information detected from one or more of the cameras 105a, 105b. Here, camera control is effected using a different set of movement sensors.

A further practical use of the second embodiment will now be described. It will be appreciated that, in general, the rear camera 105b of a communications terminal will have a greater resolution and frame rate than that of the front camera 105a which is on the same side as the touch sensitive display 102. Therefore, use of the rear camera 105b may be preferred over the front camera 105a for certain tasks involving hand-movement detection, e.g. to control a proprietary application. Also, hybrid use of both front and rear cameras 105a, 105b may be preferred to differentiate between similar gestures or between basic and advanced gestures. Therefore, using a wrist turning action, as indicated in FIG. 9, to effect switching between the front and rear cameras 105a, 105b offers advantages where the user is holding the terminal 100 and does not necessarily need to see the touch sensitive display 120. Taking the example of a proprietary application for viewing an image gallery, there may be provided three views, namely a thumbnail view, an image editing view and an image presentation view. Using only the front camera 105a for detecting both left-to-right and up-to-down handwaving gestures may be technically difficult in terms of differentiation given its more limited resolution and frame rate. Hence, by using the gesture detection application 140 to switch between the cameras 105a, 105b, one might use the front camera 105a for handwave control of the image editing and image presentation views, and then switch to the rear camera 105b for thumbnail scrolling which is effected by the wrist turning action shown in FIG. 9.

Using both cameras 105a, 105b in this way will achieve greater recognition accuracy than just one of the cameras, particularly for handwaving or ‘hovering’ recognition applications.

It will be seen that the devices described above provide for user control of one or more cameras through gestures independent of any touch-based interface, that is without the use of keys or a touch-screen. This means that application developers do not have to incorporate dedicated command buttons or icons into their GUI code to cater for touch-based camera control. Further, the or each camera can be controlled remotely from the terminal in certain situations.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

What is claimed is:

1. (canceled)

2. Apparatus according to claim 9, configured to disable an enabled camera in response to detecting a predetermined user gesture.

3. Apparatus according to claim 2, configured to control first and second cameras, wherein the gesture recognition system is further configured to enable a currently-disabled camera in response to detecting the predetermined user gesture.

4. Apparatus according to claim 9, wherein the gesture recognition system is configured to receive video data from an enabled camera and to identify from the video data one or more predetermined user gestures.

5. Apparatus according to claim 4, wherein the gesture recognition system is configured to identify, from the received video data, a gesture represented by a motion vector associated with a foreground object's change of position between subsequent frames of video data, and to compare said motion vector with a set of predetermined reference motion vector to identify a corresponding control command for the at least one camera.

6. Apparatus according to claim 9, wherein the gesture recognition system is configured to receive motion signals from a motion sensor and to identify therefrom one or more predetermined user gestures corresponding to said movement.

7. Apparatus according to claim 6, wherein the motion sensor includes at least one of an accelerometer and a gyroscope, the motion signal being generated based on at least one of a change in acceleration and a change in orientation of the apparatus.

8. Apparatus as claimed in claim 9, wherein the gesture control system is configured to disable the display of video data from a currently selected camera in response to detection of a predetermined motion gesture and to enable the display of video data from the other, non-selected camera.

9. Apparatus, the apparatus having at least one processor and at least one memory having computer-readable code stored thereon which when executed controls the at least one processor:
to receive gestural data representing a user gesture made independently of any touch-based input interface of a device;
to identify from the gestural data a corresponding camera command associated with the user gesture; and
to output the identified camera command to control the at least one camera.

10. A method comprising:
receiving gestural data representing a user gesture made independently of any touch-based input interface of a device;
identifying from the gestural data a corresponding camera command associated with the user gesture; and
outputting the identified camera command to control the at least one camera.

11. A method according to claim 10, wherein the outputted command is configured to disable a currently-enabled camera.

12. A method according to claim 11, wherein the outputted command is configured to enable a currently-disabled camera.

13. A method according to claim 10, wherein receiving gestural data comprises receiving video data from the at least one camera and identifying from the video data one or more predetermined user gestures.

14. A method according to claim 13, wherein receiving gestural data further comprises identifying a motion vector associated with a foreground object's change of position between subsequent frames of video data, and comparing said motion vector with a set of predetermined reference motion vectors to identify a corresponding control command for the or each camera.

15. A method according to claim 10, wherein receiving gestural data comprises receiving a signal from a motion sensor provided on the device, the signal being representative of movement of the device, and identifying therefrom one or more predetermined user gestures corresponding to the sensed movement.

16. A method according to claim 15, wherein the signal is received from at least one of an accelerometer and gyroscope, the signal being generated based on at least one of a change in acceleration and a change in orientation of the device.

17. A method according to claim 10, comprising, in response to detection of a predetermined motion gesture, disabling display of video data from a currently selected camera and enabling the display of video data from a non-selected camera.

18. (canceled)

19. A portable device comprising apparatus as claimed in claim 9.

20. A non-transitory computer-readable storage medium having stored thereon computer-readable code, which, when executed by computing apparatus, causes the computing apparatus to perform a method comprising:
receiving gestural data representing a user gesture made independently of any touch-based input interface of a device;
identifying from the gestural data a corresponding camera command associated with the user gesture; and
outputting the identified camera command to control the at least one camera.

21. A non-transitory computer-readable storage medium according to claim 20, wherein the computer-readable code when executed by the computing apparatus causes the computing apparatus to perform outputting the identified camera command to disable a currently-enabled camera.

22. A non-transitory computer-readable storage medium according to claim 20, wherein the computer-readable code when executed by the computing apparatus causes the computing apparatus to perform outputting the identified camera command to enable a currently-disabled camera.
